(19) United States
(12) Patent Application Publication
(10) Pub. No.: US 2006/0015577 A1
(43) Pub. Date: Jan. 19, 2006

(54) Self-service terminal

(75) Inventors: Shelley A. Bird, Dayton, OH (US); Simon J. Forrest, Dundee (GB); Adrian Shields, Fife (GB); Kenneth J. Peters, Dundee (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 10/871,624

(22) Filed: Jun. 18, 2004

(51) Int. Cl. G06F 15/16

(52) U.S. Cl. 709/219

(57) ABSTRACT

A self-service terminal (20) for displaying public information notices is described. The terminal comprises a display (52) and a network connection (32). The terminal accesses a notice database (18) to retrieve a notice associated with the terminal (20), and incorporates the retrieved notice in a screen (130) for displaying on the display (52). The terminal (20) may be an ATM. A method of supplying a notice for displaying on a self-service terminal, and a system for controlling presentation of notices on a self-service terminal are also described.

### BACKGROUND OF THE INVENTION

The present invention relates to a self-service terminal (SST) and a network thereof, such as an automated teller machine (ATM), for displaying public information notices. In particular, the invention relates to an ATM for displaying authorized notices during a transaction.

Obtaining the assistance of the general public in the search for missing or abducted children has long been a problem for law enforcement personnel. Time is of critical importance when a child has been abducted, as statistics show that 74% of children murdered, by non-family members, are killed within the first three hours of their abduction.

The “Amber Alert System” was instigated by the National Centre for Missing Children in order to assist law enforcement personnel in the US with this problem. The system is a voluntary partnership between law-enforcement agencies to activate an urgent bulletin in the most serious child abduction cases. Broadcasters utilize the Emergency Alert System, formerly called the Emergency Broadcast System in order to air a description of the child and, if possible, the abductor. In some states, electronic highway billboards are also used. However, this system is limited, both in the information it can provide (e.g. it can not show photographs of the child) and in the breadth of coverage it can provide.

It is among the objects of an embodiment of the invention to obviate or mitigate one or more of the above disadvantages or other disadvantages associated with SSTs for displaying public information notices.

### SUMMARY OF THE INVENTION

According to a first aspect of the present invention there is provided a self-service terminal for displaying public information notices, the terminal comprising a display and a network connection, characterized in that the terminal comprises means for accessing a notice database to retrieve a notice for display at the terminal, and means for incorporating the retrieved notice in a screen for presentation on the display.

The term “screen” is used herein to denote the graphics, text, controls (such as menu options), and such like, that are displayed on an SST display; the term “screen” as used herein does not refer to the hardware (for example, the LCD, CRT, or touchscreen) that displays the graphics, text, controls, and such like. Typically, when a transaction is being entered at an SST, a series of screens are presented in succession on the SST display. For example, a first screen may request a user to insert a card, a second screen may invite the user to enter his/her PIN, a third screen may invite the user to select a transaction, and so on.

The term “public information notice” or “notice” is used herein to include a notification or announcement associated with: the presentation of information to the general public for non-commercial purposes, including the dissemination of information to assist the police or other law enforcement or emergency services with a current or imminent incident. The notification may be animated or still and may include text and/or pictures.

One problem associated with providing screen space to law enforcement authorities is that the ATM application that controls the flow of screens presented to a user of the ATM is very complex. This makes it very difficult and time consuming to modify the ATM application to include an information notice in a screen. As a result, owners of ATMs would be reluctant to allow the authorities to change their notices too frequently. However, rapid updating of information notices, especially in the event of the abduction of a child or of a natural disaster (such as a flood) is essential to the operation of the Amber Alert system.

By virtue of this aspect of the invention, a notice is stored on a database rather than on the terminal. This allows a single database to be used for multiple terminals, so that each terminal accesses the same database. Each terminal can have its own database entry within this database. This also allows a third party to update the notice at the database rather than at the terminal. As each notice is associated with one or more terminals, it is possible to determine at the database which terminals will display the notice.

Preferably, the database stores a plurality of notices for each terminal, and includes rules for selecting a notice, so that a particular notice may be selected, for example, because of the time at which the database is accessed. The rules may be implemented by a calendar for scheduling display of notices. For example, if a serious assault took place at a particular time in a particular mall, all of the ATMs in that mall may display notices regarding that incident on subsequent days in a time window containing the time of the original incident. Other more general notices, for example including information relating to an abducted child could be run substantially continually on a much larger geographical basis (e.g. all-city, all-state, nationally or even internationally), as appropriate.

If a notice is of particular urgency, it may be flagged, for example, in the case of a child abduction, and that notice may be given priority for a period of time such that it is the first, or in some cases the only, notice issued to terminals. Preferably, the means for accessing the notice database to retrieve a notice includes a Web browser (such as Microsoft (trademark) Internet Explorer or Netscape (trademark) Communicator) or a Web browser component (such as the HotJava HTML component from Sun (trade mark)).

Preferably, the Web browser or Web browser component is embedded in a program that controls the operation of the SST. Preferably, the Web browser or browser component is operable to connect only to the database and not to other Web sites.

Preferably, the means for accessing the notice includes a program for transmitting an identifier to the database. The identifier may identify the SST, the user of the SST, and such like information. The identifier may be a URL (uniform resource locator) or a field within a URL.

Preferably, the means for incorporating the retrieved notice in a screen includes a terminal program for executing the Web browser or browser component.

Preferably, the terminal program is operable to allocate screen space to the Web browser or Web browser component in accordance with predefined allocation times. The allocation times may include: “idle time” during a transaction; a period prior to a user entering his/her card; or such like.

According to a second aspect of the invention there is provided a method of displaying public information notices on a self-service terminal, characterized by the steps of: accessing a database of authorized notices, retrieving from the database an authorized notice associated with the terminal, and displaying the retrieved notice.

The step of retrieving an authorized notice from the database may include the further step of providing the database with an identifier associated with the terminal.

According to a third aspect of the invention there is provided a method of supplying a notice for displaying on a self-service terminal, characterized by the steps of: accepting via a network an identification signal from a terminal located on the network, accessing a notice database to retrieve an authorized notice associated with that terminal, and transmitting the retrieved notice to the terminal for displaying at that terminal.

Each terminal may have a plurality of notices associated with it. The notice that is retrieved may depend on the time at which the database was accessed.

According to a fourth aspect of the invention there is provided a computer readable medium having stored thereon instructions for causing a processing unit to execute the method of the second aspect of the invention.

According to a fifth aspect of the invention there is provided a computer readable medium having stored thereon instructions for causing a processing unit to execute the method of the third aspect of the invention.

According to a sixth aspect of the invention there is provided a system for controlling presentation of public information notices on a self-service terminal, comprising a self-service terminal interconnected to a server; characterized in that the system comprises a notice database for storing authorized notices; and the server is operable to access the notice database in response to a request from the terminal, to retrieve a notice associated with the terminal, and to transmit the retrieved notice to the terminal for displaying at the terminal.

Preferably, the system is configured to allow an authorized user to update the stored notice.

Preferably, the server includes a JAVA (trade mark) Servlet associated with each descriptive field (hereinafter referred to as a “field Servlet”), so that the field Servlet for each field translates the entry for that field into a format for generating HTML (hypertext markup language) therefrom, and stores the translated entry as part of a database entry for a notice. As a result of the activity of the field Servlets, each database entry comprises a plurality of translated entries that together form an artificial language notice. This allows a different Servlet (hereinafter referred to as a “database Servlet”) to generate an HTML page (a notice as it appears to a user) from the database entry (which is an artificial language version of the notice appearing to a user).

Preferably, the system includes a screening system for screening each notice to determine if the information meets an acceptance criterion.

Preferably, each notice is screened (vetted) prior to storing the notice in the database. In a particularly preferred embodiment, the descriptive fields are screened prior to being stored in the database. For example, a text field may be screened by keyword searching.

Alternatively, each notice may be stored in the database prior to being screened, but may only be accessed when the notice has been screened.

According to a seventh aspect of the present invention there is provided a self-service terminal operable to connect to a first server for authorizing a transaction, and to a second server for retrieving an authorized notice associated with the terminal for displaying to a user of the terminal.

According to an eighth aspect of the present invention there is provided a network of self-service terminals comprising a server interconnected to a plurality of SSTs, characterized in that the network includes a database of authorized public information notices, each notice having an associated display criteria, whereby each SST is operable to request an authorized notice from the database, and the server is operable to match a notice with each SST based on the display criteria.

According to a ninth aspect of the present invention there is provided a self-service terminal for displaying public information notices, the terminal comprising a display and a network connection, characterized in that the terminal comprises means for incorporating a notice in a screen for displaying on the display.

According to a tenth aspect of the present invention there is provided a method of displaying public information notices on a self-service terminal, characterized by the steps of: incorporating a notice in a screen for displaying on the display and displaying the retrieved notice.

The advantage of storing the notices on a database is that the database can provide a secure repository for authorized participants, such as the law enforcement authorities.

The advantage of using descriptive fields to describe a notice is that a simple interface can be provided for describing a notice. This means that an authorized person does not need to know how to create a Web page in order to enter a notice on the system.

According to a seventh aspect of the invention there is provided a self-service terminal operable to connect to a first server for authorizing a transaction, and to a second server for retrieving a public information notice associated with the terminal for displaying to a user of the terminal.

Preferably, the terminal connects to the second server at least once during each transaction.

The first server may be accessible only through a private network, such as an Intranet; whereas, the second server may be accessible through a public network, such as the Internet, or a private network, such as an Intranet or an Extranet.

Aspects of the present invention also have the advantage that different notices may be shown on an SST depending on the time of day, the location of the SST, the user of the SST, or such like.

### BRIEF DESCRIPTION OF THE DRAWING

These and other aspects of the invention will be apparent from the following specific description, given by way of example, with reference to the accompanying drawings, in which:

FIG. 1 is a block diagram of an SST system according to one embodiment of the invention;

FIG. 2 is a block diagram showing a terminal and a server of FIG. 1 in more detail;

FIG. 3 is a block diagram showing the terminal of FIG. 2 in more detail;

FIG. 4 is a block diagram showing the server of FIG. 2 in more detail;

FIG. 5 is a block diagram illustrating the interaction between some of the components in the system of FIG. 1;

FIG. 6 illustrates a set of descriptive fields provided by the server of FIG. 2 for use in preparing a notice;

FIG. 7 is a flowchart illustrating the steps involved in displaying a notice on one of the terminals of FIG. 1; and

FIG. 8 is an illustration of a screen displayed during an “idle time” on one of the terminals of FIG. 1.

### DETAILS OF THE INVENTION

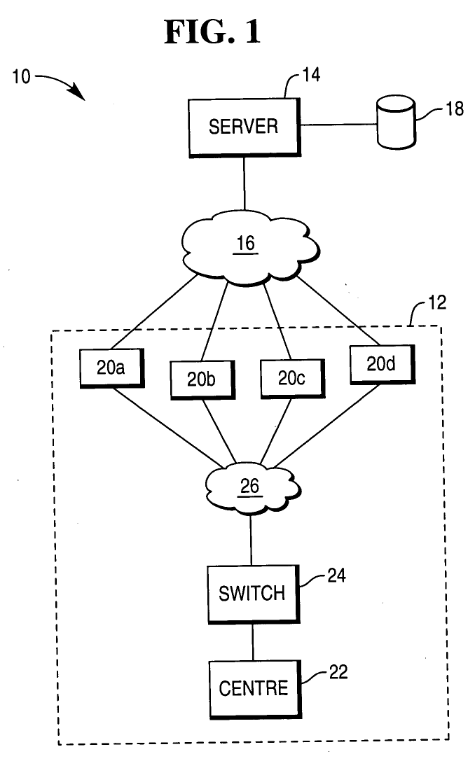

Referring to FIG. 1, which shows an SST system 10 in the form of an ATM system. ATM system 10 comprises an ATM network 12 connected to a server 14 via a public access network 16 in the form of the Internet. The server 14 is connected to a database 18 for storing public information notices.

The ATM network 12 comprises a plurality of ATMs 20 (four of which, 20a, 20b, 20c, 20d, are shown in FIG. 1) interconnected to a financial institution's authorization centre 22 via a switching device 24 and a secure private network 26 in the form of an Intranet.

In a similar way as for conventional ATM networks, the switching device 24 is used for routing financial transaction authorization requests from the ATMs 20 to the authorization centre 22. As will be appreciated by those of skill in the art, the switching device 24 and the authorization centre 22 may be incorporated into a single server (an authorization server). It will also be appreciated that the switching device 24 is able to route authorization requests to authorization centers operated by other financial institutions and to financial services companies.

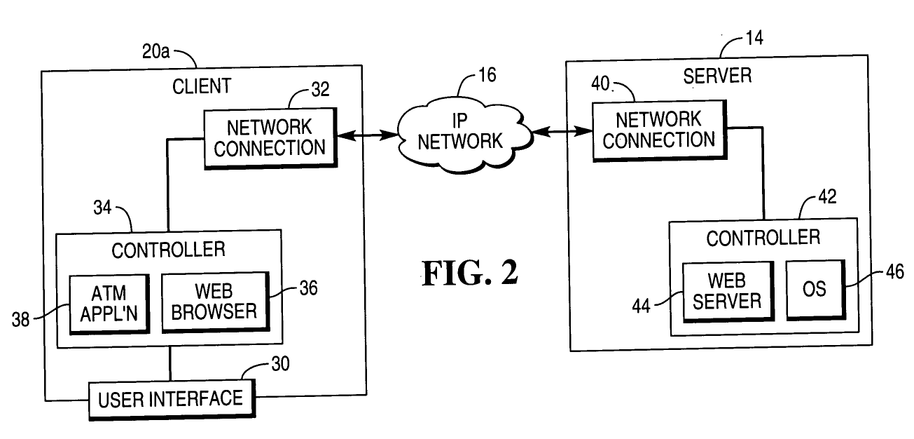

Reference is now made to FIG. 2, which is a block diagram showing one of the ATMs 20a and the server 14 of FIG. 1 in more detail. ATM 20a operates as a client of server 14 and includes a user interface 30; a network connection 32 providing a link to the server 14 via the Internet 16; and a controller 34 for controlling the operation of the ATM 20a. The controller 34 incorporates an embedded Web browser component 36 and an ATM application 38 for controlling modules in the ATM 20a.

The server 14 also has a network connection 40 and a controller 42 incorporating a Web server 44 and a server operating system 46 for controlling the server 14.

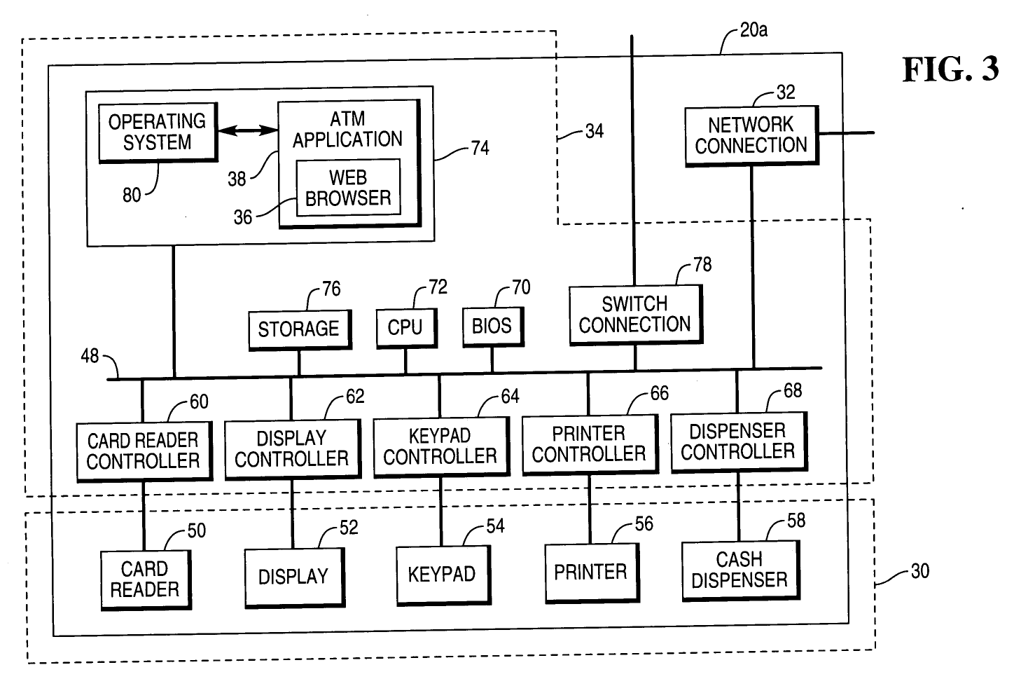

Referring to FIG. 3, which shows ATM 20a in more detail, a system bus (or a plurality of system buses) 48 interconnects the network connection 32 and the controller 34 to allow mutual intercommunication, and also connects various modules within the controller 34, as described below.

The user interface 30 comprises the following user interface elements (peripheral devices): a card reader 50, a display 52, an encrypting keypad 54, a printer 56, and a cash dispenser 58.

The controller 34 comprises modules for driving the user interface elements 50 to 58, namely: card reader controller 60, display controller 62, keypad controller 64, printer controller 66, and dispenser controller 68. These user interface elements (50 to 58) and associated controllers (60 to 68) are standard modules that are used on conventional ATMs and will not be described in detail herein.

The controller 34 also comprises a BIOS 70 stored in non-volatile memory, a microprocessor 72, associated main memory 74, storage space 76 in the form of a magnetic disk drive, and a dedicated switch connection 78 for connecting the ATM 20a to the authorization centre 22 (FIG. 1).

The embedded Web browser component 36 is a HotJava (trade mark) browser bean component, which is embedded within the ATM application 38. For simplicity, hereinafter the embedded browser component 36 will be referred to as a browser or a Web browser.

In use, the main memory 74 is loaded with the ATM operating system kernel 80, and the ATM application 38 for controlling the operation of the ATM 20a.

The ATM application 38 includes the sequence of screens used in each transaction flow. The ATM application 38 is configured so that each screen that is presented to a user during an “idle time” includes screen space that is allocated to the Web browser 36. “Idle times” include, for example, when the ATM 20a requests authorization of a transaction, when the ATM 20a prints a receipt or a statement, or such like event. In addition, the attractor screen, which is utilized prior to the start of a transaction by a customer, can also be allocated to the Web browser.

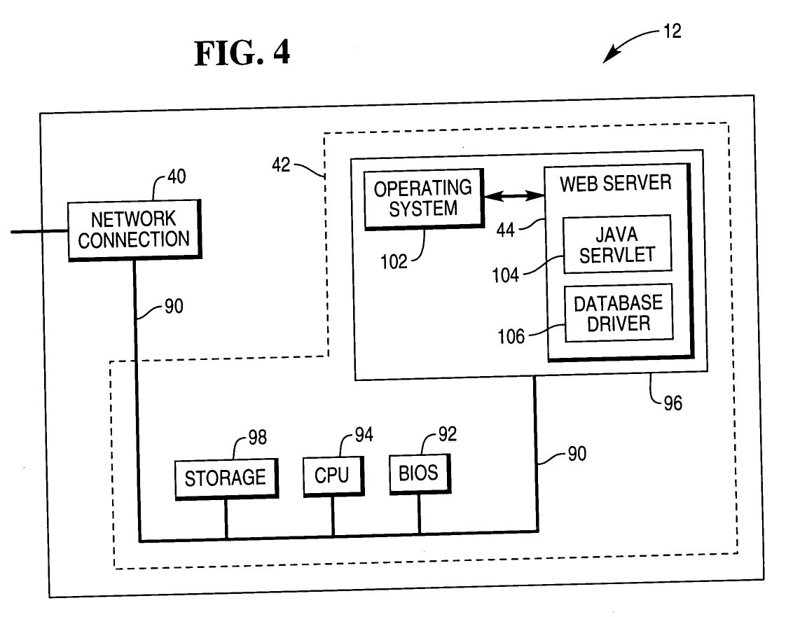

Referring to FIG. 4, which shows remote server 14 in more detail, a system bus (or buses) 90 connects the network connection 40 to the controller 42. The controller 42 further comprises a BIOS 92 stored in non-volatile memory, a microprocessor 94, associated main memory 96, and storage space 98 in the form of a magnetic disk drive.

The server operating system 102 and the Web server 44 are stored on the magnetic drive 98. In use, the main memory 96 is loaded with the server operating system kernel 102 and the Web server 44. In this embodiment the Web server 44 is the Java Web Server (trademark).

The Java Web server 44 includes a server application 104 for invoking two types of Java Servlets (104a, 104b), and the server 44 supports a database application programming interface (API) 106 in the form of a JDBC (Java DataBase Connectivity) API for accessing database 18 (FIG. 1).

The Java Servlets 104 perform a number of different tasks, as will be described in more detail below. The Java Web Server 44 also provides session management, thread management, administration and security features; as is well known to those of skill in the art.

The database application interface 106 is a database driver that provides SQL access to the database 18. The Java Servlets use the JDBC API 106 to obtain information from the database 18 for use in generating HTML files in response to a request from an ATM 20.

A Java Servlet is software code that is used to generate information dynamically. Each Servlet must be registered with the Web server so that the Web server can distinguish between a request for a Servlet and a request for a Web page. When a registered Servlet is requested by a remote Web browser, the Web server instantiates the Servlet. Once instantiated, the Servlet remains in memory for a period of time awaiting further invocation by the Web browser.

When a third party (such as an authorized representative of a law enforcement service) wishes to utilize “notice space” on one or more of the ATMs 20 (FIG. 1) in ATM network 12, the financial institution that owns the ATM network 12 (FIG. 1) provides the representative with a log-in facility (which may include a username and a pass code) to allow the representative to access the server 14. Alternatively, there may be an authority, such as the authority that administers the Amber Alert system. That authority could then vet representatives and administer the placement of notices on the database.

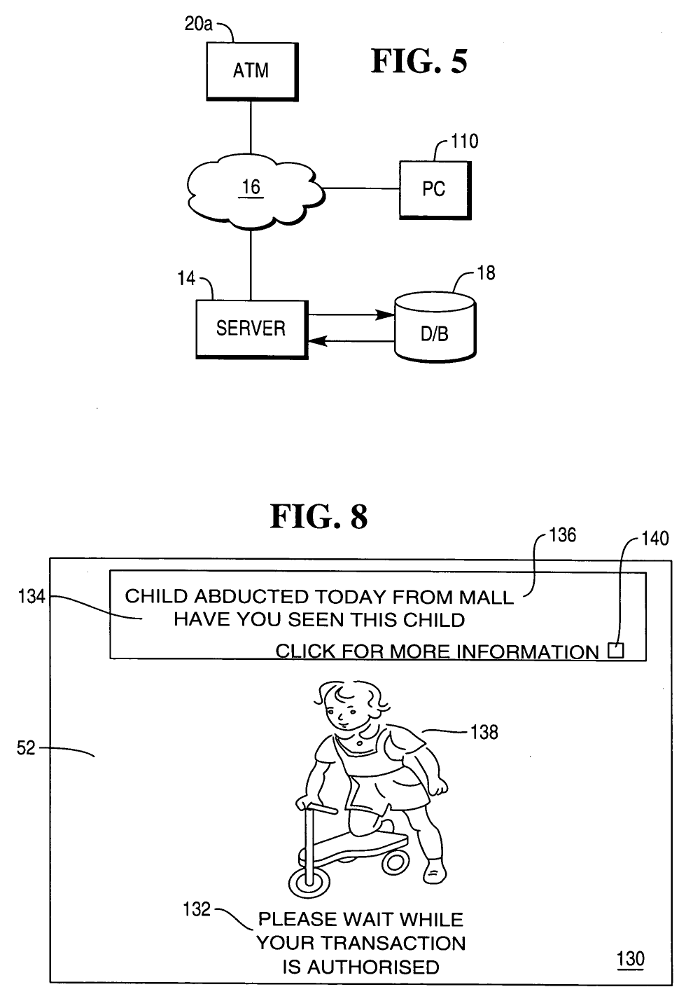

Referring to FIG. 5, the representative can access the server 14 using a personal computer (PC) 110 having Internet access. After logging-in to the server 14, the campaign manager can enter a notice comprising text data and/or image data and/or sound data for storing on the database 18. The notice may include animation and/or still images.

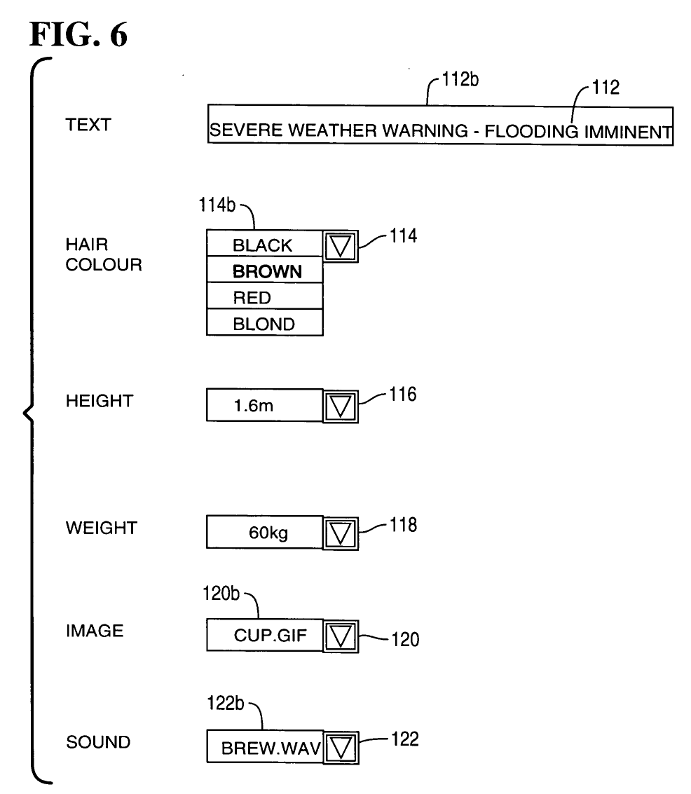

In this embodiment, the server 14 is configured for use by representatives who are not specialists at designing Web pages. To assist these representatives, the server 14 instantiates a series of Servlets (field Servlets 104a). Each field Servlet 104a presents the representative with a descriptive field for receiving an entry, as shown in FIG. 6. The first field shown in FIG. 6 is a text field 112, which allows the representative to type in the text to be displayed as part of the notice. The second field 114 is a “hair color” field, the third field 116 is a “height” field, the fourth field 118 is a “weight” field, the fifth field 120 is an “image” field, and the sixth field 122 is a “sound file” field.

Where there are a limited number of options available, for example fields 114 to 122, a drop-down menu format is used to facilitate rapid selection by the representative. For field 114, arrow 114a presents the user with the various possibilities for selection; in FIG. 6, the “BROWN” option is being selected for field entry 114b.

The field Servlet associated with each field (114 to 122) translates the field entry into a format for generating HTML.

The representative is then prompted to enter display criteria that determine when and where the notice is shown. The display criteria include:
(1) The ATMs 20 on which the notice is to be displayed, for example, ATMs 20a and 20c;
(2) The times at which the notice is to be displayed, for example, Wednesday mornings between 10 and 11.30 am.

Alternatively, particularly urgent messages can be displayed at all possible times, for a predetermined duration.

The Servlet for the text field 112, the Servlet for the image field 120, and the Servlet for the sound field 122, each conveys its respective entry (112b, 120b, 122b) via email to an authorized person for screening.

The authorized person may be an employee of, or be contracted, by the financial institution or the managing authority to screen proposed entries.

When the authorized person approves the text, image, and sound entries (112b, 120b, 122b), the translated field entries of fields 112 to 122 are stored in a single entry in the database 18.

At any time the authorized representative may log-in to the server 14 and change the notice (by changing the field entries) and/or the display criteria. Any change to the notice that involves a new text entry (112b), image entry (120b), or sound entry (122b), results in the new entry or entries being conveyed to the authorized person for screening prior to being saved on the database 18.

An authorized person will not approve an entry if it does not meet an acceptance criterion. The acceptance criterion may be based on:
(1) For a text or sound entry, the absence of certain keywords that are deemed offensive or inappropriate for display on a public access terminal such as ATM 20a;
(2) For an image entry, the absence of a predetermined amount of skin tone.

The server 14 updates the calendar to record which ATMs 20 are being used for the new notice, so that the calendar provides a schedule indicating which notices are to be displayed on which ATMs 20 at each time of every day. The server 14 uses this calendar for determining which notice is to be transmitted to an ATM at any particular time.

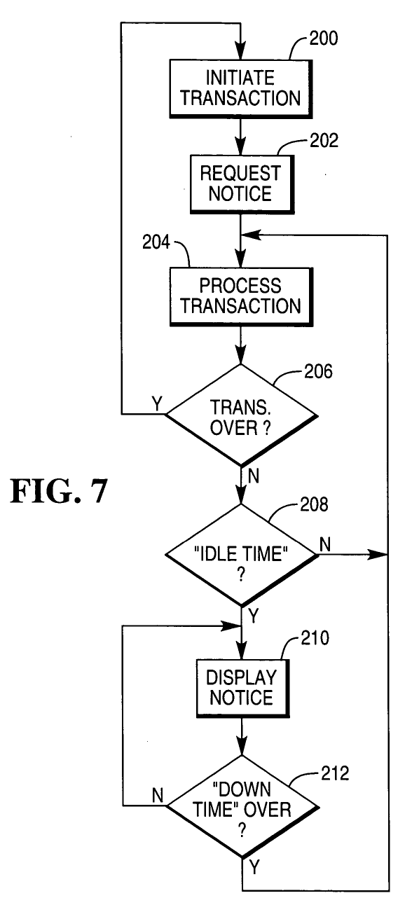

The operation of ATM 20a will now be described with reference to FIGS. 3 and 7. Initially, a user inserts his card into the ATM 20a. On receiving the card, the ATM application 38 initiates a transaction (step 200) and presents a screen on the display inviting the user to enter a PIN.

The ATM application 38 then requests a notice (step 202) from the server 14 (as will be described in more detail below) and stores this notice in memory 74.

The ATM application 38 processes a transaction (step 204) according to the predefined application flow programmed in the ATM application 38. Those parts of the application flow which give rise to an “idle time”, for example, where a cash withdrawal is to be authorized, include a routine for:
(1) Allocating Web browser space on the screen associated with the “idle time” so that a Web browser window appears on the screen for the duration of the “idle time” and
(2) Activating the Web browser to display the stored notice (from step 202) in this allocated space.

This is illustrated in FIG. 7 by steps 206 to 210.

When the “idle time” is over, the allocated space is removed and the application flow proceeds (step 212).

FIG. 8 illustrates a typical screen 130 presented on the display 52 during a transaction “idle time”. The screen 130 includes transaction text 132 relating to the transaction being conducted, plus an Amber Alert notice 134 comprising text 136 and an image 138.

The user may obtain further information by, for example, ticking a box 140 on the screen 130. Information, in the form of a response to a question, such as “Is the child in the area now?” may also be input by the user. Additional input may also be provided by the user.

When the “idle time” is over, the ATM application 38 closes the Web browser 36 and the next screen in the application flow is presented to the user.

Various modifications may be made to the above described embodiment within the scope of the invention, for example, in other embodiments multiple authorized persons may be used to screen notices, and the server 14 may convey proposed notices to each authorized person in turn until an authorized person is available to screen the notices. Intelligent agent technology may be used to convey the notices between authorized persons.

In one type of embodiment the server may generate Web pages using PERL or CGI scripts. In a second type of embodiment Microsoft (trade mark) active server pages may be used instead of JAVA (trade mark) Servlets. In a third type of embodiment the server may generate Web pages using dynamic HTML.

In another embodiment the ATM may request a notice after each transaction is completed so that the notice is available immediately an “idle time” occurs. Also, the ATM may print a receipt containing information, such as a telephone number for a police incident centre plus a reference number or other token to identify the case in question.

What is claimed is:

1. A self-service terminal for displaying public information notices, the terminal comprising:
a display;
means for accessing a notice database to retrieve a notice associated with the terminal; and
means for incorporating the retrieved notice in a screen for presentation on the display.

2. A terminal according to claim 1, wherein the means for incorporating the retrieved notice in a screen includes a terminal program for executing a Web browser.

3. A terminal according to claim 2, wherein the terminal program is operable to allocate screen space to the Web browser in accordance with predefined allocation times.

4. A method of displaying public information notices on a self-service terminal, the method comprising:
accessing a database of authorized notices;
retrieving from the database an authorized notice associated with the terminal; and
displaying the retrieved notice.

5. A method as claimed in claim 4, wherein a notice of particular urgency is flagged and given seniority for a period of time such that it is the first or in some cases the only notice issued to terminals.

6. A method as claimed in claim 4, wherein if an incident took place at a particular time, appropriate terminals are arranged to display notices regarding that incident on subsequent days in a time window containing the time of the original incident.

7. A method as claimed in claim 4, wherein if an incident took place at a particular location, appropriate terminals adjacent that location are arranged to display notices regarding that incident.

8. A method of supplying a notice for displaying on a self-service terminal, the method comprising:
accepting via a network an identification signal from a terminal located on the network;
accessing a notice database to retrieve an authorized notice associated with that terminal; and
transmitting the retrieved notice to the terminal for displaying at that terminal.

9. A system for controlling presentation of public information notices on a self-service terminal, the system comprising:
a self-service terminal;
a notice database for storing authorized notices; and
a server interconnected to the self-service terminal and including means for accessing the notice database in response to a request from the terminal, means for retrieving a notice associated with the terminal, and means for transmitting the retrieved notice to the terminal for displaying at the terminal.

10. A system according to claim 9, wherein an authorized user is allowed to update the stored notice.

11. A system according to claim 9, wherein the server includes means for allowing a user to enter descriptive fields relating to a notice.

12. A system according to claim 9, further comprising a screening system for screening each notice to determine if the information meets an acceptance criterion.

13. A self-service terminal comprising:
means for connecting to a first server for authorizing a transaction; and
means for connecting to a second server for retrieving an authorized notice associated with the terminal for displaying to a user of the terminal.

14. A self-service terminal network comprising:
a database of authorized public information notices, each notice having an associated display criteria;
a plurality of self-service terminals (SSTs), each self-service terminal (SST) including means for requesting an authorized notice from the database; and
a server interconnected to the plurality of SSTs, the server including means for matching a notice with each SST based on the display criteria.

15. A self-service terminal for displaying public information notices, the terminal comprising:
a display; and
means for incorporating a notice in a screen for displaying on the display.

16. A method of displaying public information notices on a self-service terminal, the method comprising:
incorporating a notice in a screen for displaying on a display; and
displaying the retrieved notice.

17. A method as claimed in claim 16, wherein a notice of particular urgency is flagged and given seniority for a period of time such that it is the first or in some cases the only notice issued to terminals.

18. A method as claimed in claim 16, wherein if an incident took place at a particular time, appropriate terminals are arranged to display notices regarding that incident on subsequent days in a time window containing the time of the original incident.

19. A method as claimed in claim 16, wherein if an incident took place at a particular location, appropriate terminals adjacent that location are arranged to display notices regarding that incident.
